(19) United States
(12) Patent Application Publication
(10) Pub. No.: US 2007/0214019 A1
(43) Pub. Date: Sep. 13, 2007

(54) PATIENT DATA ARCHIVING APPARATUS

(76) Inventors: Twins Shui Hing YIU, Hornsby Heights (AU); Jenkin Ji Khuen TONG, Northbridge (AU)

Correspondence Address: LADAS & PARRY LLP, 224 SOUTH MICHIGAN AVENUE, SUITE 1600, CHICAGO, IL, 60604, US

(21) Appl. No.: 11/682,397

(22) Filed: Mar. 6, 2007

(30) Foreign Application Priority Data
Mar. 10, 2006 (AU) 2006901233

(51) Int. Cl. G06F 19/00

(52) U.S. Cl. 705/3

(57) ABSTRACT

A method of archiving on a removable media, desired information retrieved from a medical device implanted within a patient. The method comprising the steps of transferring patient data from a medical device to a computer, performing an operation on said patient data within the computer to separate it into a first category of desired information and a second category of undesired information, copying desired information to removable media from computer, and deleting undesired information from computer.

### FIELD OF THE INVENTION

The present invention relates to a patient data archiving apparatus and system.

### BACKGROUND OF THE INVENTION

It is necessary for health professionals and technicians to access, archive and subsequently analyse patient data stored in implanted medical devices and their control units. Such implanted medical devices include heart pumps, pacemakers and the like. A difficulty sometimes arises when technicians or health professionals must access and archive such patient data, as they must under certain circumstances have authorisation or consent where confidential information forms part of that patient data. In many instances the technician or health professional only needs to utilise desired information not related to the confidential information, but needs authorisation or consent as the “desired information” is bundled or stored together with “undesired information” that includes confidential information.

In the past, there have been many systems and apparati that are capable of archiving patient data. One example of a patient data archiving system is described within U.S. Pat. No. 6,970,827—Zeltzer et al. This document describes a system that stores and archives patient data across a wireless network. This system generally exposes confidential patient data to the possibility of disclosure as the network is primarily wireless and is exposed to unauthorised access. Additionally, the patient data transmitted includes confidential details and thereby allows the patient to be wirelessly identified which is of significant disadvantage for data security reasons.

There has generally been a long felt need for a system or apparatus that securely archives patient data whilst limiting the possibility of unauthorised access.

U.S. Pat. No. 6,044,349—Tolopka et al describes a system whereby data may be securely archived onto a smart card. However, this document fails to apply the principle to patient data or medical applications rather said document is limited to banking applications and is not suitable for medical applications. Additionally, the patient data includes data fields that may identify the patient.

The present invention aims to or at least address or ameliorate one or more of the disadvantages associated with the above mentioned prior art.

### BRIEF DESCRIPTION OF THE INVENTION

According to a first aspect the present invention consists in a method of archiving on a removable media, desired information retrieved from a medical device implanted within a patient, said method comprising the steps of transferring patient data from said medical device to a computer, performing an operation on said patient data within said computer to separate it into a first category of desired information and a second category of undesired information, copying said desired information to said removable media from said computer, and deleting said undesired information from said computer.

Preferably, said method comprises compressing said desired information prior to transferring same to said removable media.

Preferably, said undesired information is confidential information.

According to a second aspect the present invention consists in an apparatus for archiving on a removable media, desired information retrieved from a medical device implanted within a patient, said apparatus adapted to engage with a computer that has patient data therein that has been transferred from said medical device, said apparatus adapted to perform an operation on said patient data that separates it into a first category of desired information and a second category of undesired information, said apparatus further adapted to copy said desired information to said removable media and to delete said undesired information from said computer.

Preferably, said apparatus compresses said desired information prior to transferring same from said computer to said removable media.

Preferably, said apparatus and said removable media are housed within a single unit.

Preferably, said removable media is a USB flash drive.

### BRIEF DESCRIPTION OF THE DRAWINGS

Embodiments of the present invention will now be described with reference to the accompanying drawings wherein:

FIG. 1 is a schematic view of a first embodiment of the present invention;

FIG. 2 is a schematic view of a second embodiment of the present invention;

FIG. 3 is a flowchart depicting steps taken by the second embodiment;

FIG. 4 is a representation of a screen of a portion of the second embodiment;

FIG. 5 is a representation of a screen of a portion of the second embodiment;

FIG. 6 is a representation of a screen of a portion of the second embodiment; and

FIG. 7 is a representation of data collected and processed by either embodiment.

### BRIEF DESCRIPTION OF THE PREFERRED EMBODIMENTS

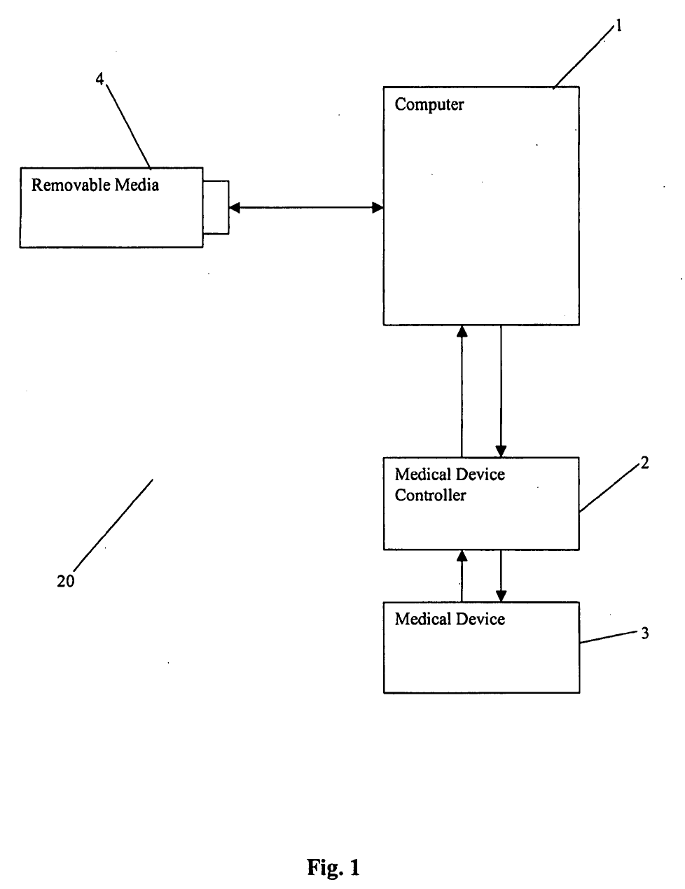

A first embodiment of the present invention is depicted in FIG. 1. In this embodiment, a system 20 is depicted comprising: a medical device 3 connected to a medical device controller 2, a computer 1 connected to the medical device controller 2 and a type of removable media 4 is connected to the computer 1.

The medical device 3 is preferably an implanted medical device such as a pacemaker, neural simulator, or rotary blood pump. The medical device 3 is connected to a preferred external medical device controller 2 and this connection may be achieved by a percutaneous lead or a type of wireless technology (including transcutaneous energy transfer systems), which is typically a short range device. The connection provides a means to transceiving data and power between the medical device controller 2 and the medical device 3. In some instances, the medical device 3 may include the medical device controller 2.

Preferably, the medical device controller 2 receives sensor data from the medical device 3. This data is used in a feedback loop and is used to automatically determine the most appropriate operating parameters for the medical device 3. These operating parameters are then translated into instructions for the medical device 3 and sent to it by the connection means. Also, the medical device controller 2 may be able to log errors, received data, and medical device 3 operating parameters. These logs may be recorded on volatile or non-volatile memory inbuilt within the medical device controller 2. The medical device controller 2 may also include a power source (not shown) to power the medical device 3. The power source may be a rechargeable battery permanently or temporarily connected to the medical device controller 2, depending on the circumstances and the type of medical device 2. Preferably, the logs may form part of the overall patient data.

The computer 1 may be selectively connected the medical device controller 2. This connection may be achieved by the use of wireless technology or cables. This wireless technology may include standard wireless protocols including Bluetooth™ interfaces. The connection between the medical device controller 2 and the computer 1 generally only transceives said data and instructions. However, the connection may also be used to supply power to the either of the medical device controller 2 or the medical device 3.

Preferably, the computer 1 is able to download via the connection to the medical device controller 2, patient data including logs, data and information. The computer 1 is capable of displaying these logs, data and information on a screen by the use of a graphical user interface (herein referred to as a ‘GUI’). Generally, the logs, data and information are saved or stored on the computer 1 by the GUI, when operated by a user.

The removable media 4 is also preferably connected to the computer 1. The removable media 4 is preferably a type of media capable of recording and saving computer data, whilst be resilient enough to endure physical requirements of medical environments. Preferably, the removable media may be: USB flash drives, USB keys, USB dongle devices; smart card devices, CDs or DVDs. These types of devices are typically resilient enough to resist normal wear and tear as they are relatively impervious to scratches and dust that adversely affects other forms of removable media such as compact discs and floppy discs. The preferred removable media 4 generally include a durable solid state design which is capable of resisting more physical damage.

Additionally, wherein the removable media 4 includes a USB flash drive, which also may be described as a key or dongle, the connection via the Universal Serial Bus (herein referred to as ‘USB’) port of the computer may allow the removable media 4 to be connected to almost all modem computers without the need for additional interfaces to be added to the computer. USB flash drives may also be replaced with smart card devices that may allow some of the same benefits of a USB flash drive but to a lesser extent in terms of maximum data storage.

Preferably, the patient data is received by the computer 1 from several sources. These sources may include: networks to which the computer 1 is connected, keyboards or other direct input devices; medical device controller 2; and medical device 3. Patient data is stored or saved on the computer 1. At the discretion of a user, the patient data may be archived and in doing so patient data is copied to the removable media 4 and may also deleted from the computer 1.

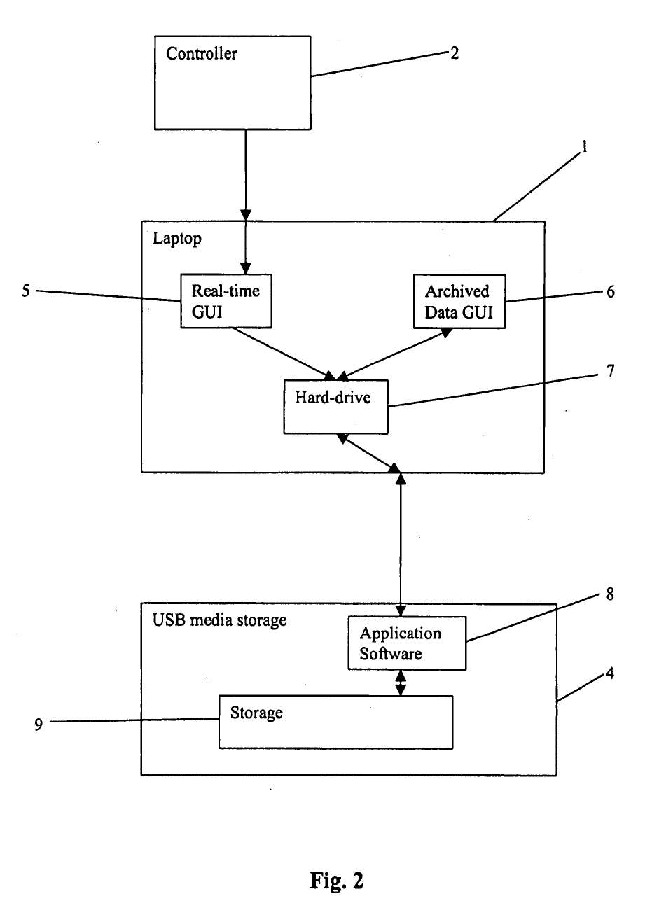

FIG. 2 depicts a second embodiment of the present invention wherein the system 20 includes a laptop computer 1 which replaces the basic computer depicted in FIG. 1. The laptop computer 1 includes two different GUIs: a real-time GUI 5; and an archived data GUI 6.

The real-time data GUI 5 receives data and information from the medical device controller 2 and displays this data and information in real-time on the screen of the laptop computer 1. The laptop computer 1 is capable of selectively saving this data and information on its hard drive 7.

The archived data GUI 6 is capable of downloading stored data and information of the controller 2 as well as accessing data and information stored on the hard drive 7. This archived data GUI 6 allows users to selectively review and analyse patient data, when the medical device 3 or the medical device controller 2 is not connected to the laptop computer 1. The user may be able to select a date and a patient and then the archived data GUI 6 graphically displays the information and data on the laptop computer's 1 screen.

Preferably, the laptop computer 1 via use of the archive data GUI 6 is able to download all logs, data and information stored on the medical device controller 2. It may also be possible to download data and information in a restricted timeframe (for example the period of the last 30 days).

Additionally, the laptop computer 1 may be able to amend or instruct the medical device controller 2 to change its behaviour characteristics and in doing so allow the medical device controller 2 to instruct the medical device 3, differentially according to the situation. The data recording parameters of the medical device controller 2 may also be amended to suit the circumstances. For example, wherein the patient requires continuous care and is confined to a hospital, the medical device controller 2 may store high resolution data over a short period. Whilst, the patient is outside the hospital environment, the medical device controller 2 may preferably store and record relatively lower resolution data over a longer or extended time period.

In this second embodiment, the removable media 4 is a USB media storage device such as USB flash drive. This USB flash drive includes: application software 8 and a storage mechanism 9. Generally, the application software 8 is stored on the storage mechanism and is accessible to a user using the laptop computer 1 when the USB flash drive is connected. Generally, the user may be able to initiate the application software 8 and wherein the application software 8 archives data from the laptop computer 1 to the storage mechanism 9 by copying data and information from the hard drive 7 to the storage mechanism 9 and then preferably deleting the data and information from the laptop computer 1. The deletion of data and information from the laptop computer 1 may be preferred for convenience and lack of confusion but it is not necessary to the overall functioning of this embodiment.

In other embodiments, the application software 8 may be automatically initiated when the removable media 4 is inserted or connected to the computer 1. As the removable media 4 would be detected and initialised by the computer 1.

The storage mechanism 9 within the USB flash drive may be preferably encrypted and may only be accessed when an appropriate password is entered by a user into the laptop computer 1.

The main advantage of the application software 8 being saved and run from the USB flash drive is that the system is more convenient for the user. The increased convenience may be achieved through the portability of the removable media used. Additionally, the application software 8 being saved on storage mechanism may make the application software 8 more secure, if the USB flash drive is encrypted with a password.

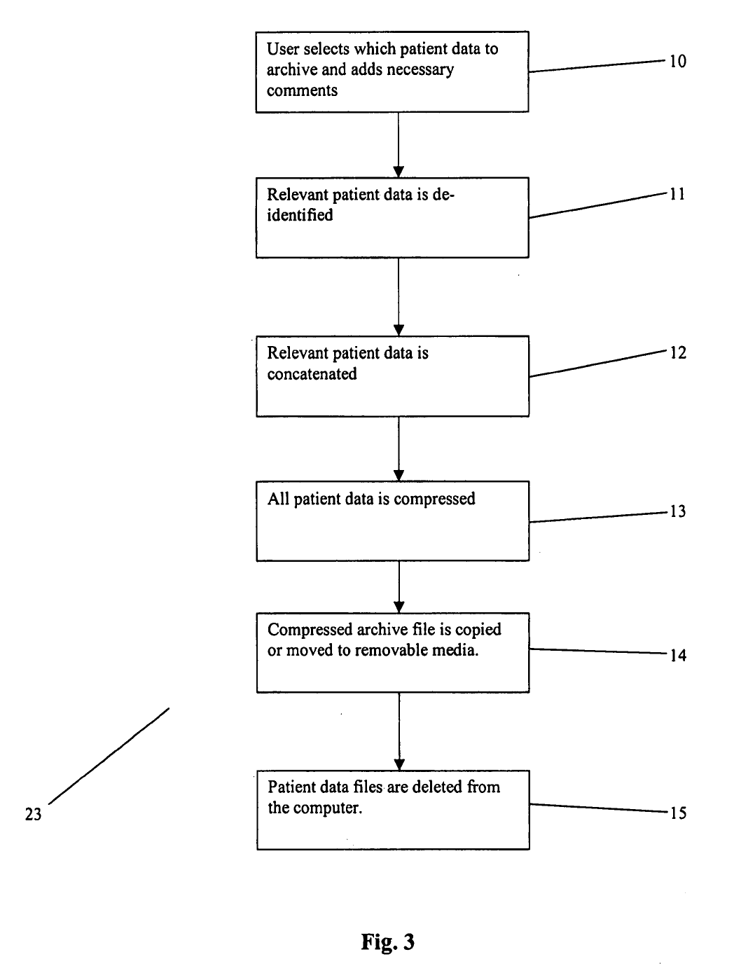

FIG. 3 diagrammatically depicts steps involved in the process 23 or method of archiving data and information from the computer 1 to the removable media 4. The first step 10 in the process is for the user to run the application software 8 and select the “desired information” from patient data to archive and comments may be added to the data when the user decides comments are necessary. The selection by the user of the patient data to be archived is generally completed.

The preferred second step 11 may be to de-identify the patient data to be archived. This generally requires the application software 8 to remove undesired information (or confidential information) such as data fields and comments that relate to patient identification including, but not limited to: insurance identifiers, patient's name, patient's date of birth, and patient's address. The primary advantage of removing the patient's identity from the patient data is to ensure patient confidentiality and to allow medical device manufacturers to access information without breaching patient confidentiality.

The third step 12 may be to concatenate the patient data and thereby join all of the patient data into one file allowing for easier archiving and possibly subsequent viewing of the patient data. Preferably, the application software 8 automatically does this when its archiving function is initiated by the user.

The fourth step 13 is for the application software 8 to automatically compress the patient data so that it takes up a smaller space on the storage 9. The preferred compression mechanism is to change the format of the files to be archived to a ZIP file rather than the raw data files which generally contain textual information.

The fifth step 14 is to copy the compressed patient data from the computer 1 to the USB flash drive or the removable media 4. This is achieved by the application software 8 after the archiving process is complete.

Once the patient data is securely copied to the USB flash drive, the application software 8 initiates the final sixth step 15, which is to delete the source patient data from the computer 1.

Additionally, the process 23 may include an additional step (not shown), wherein the additional step for the GUI to verify the integrity of the patient data archived from the computer 1 to the removable media 4. This verification step is preferably implemented when data integrity is of a high importance.

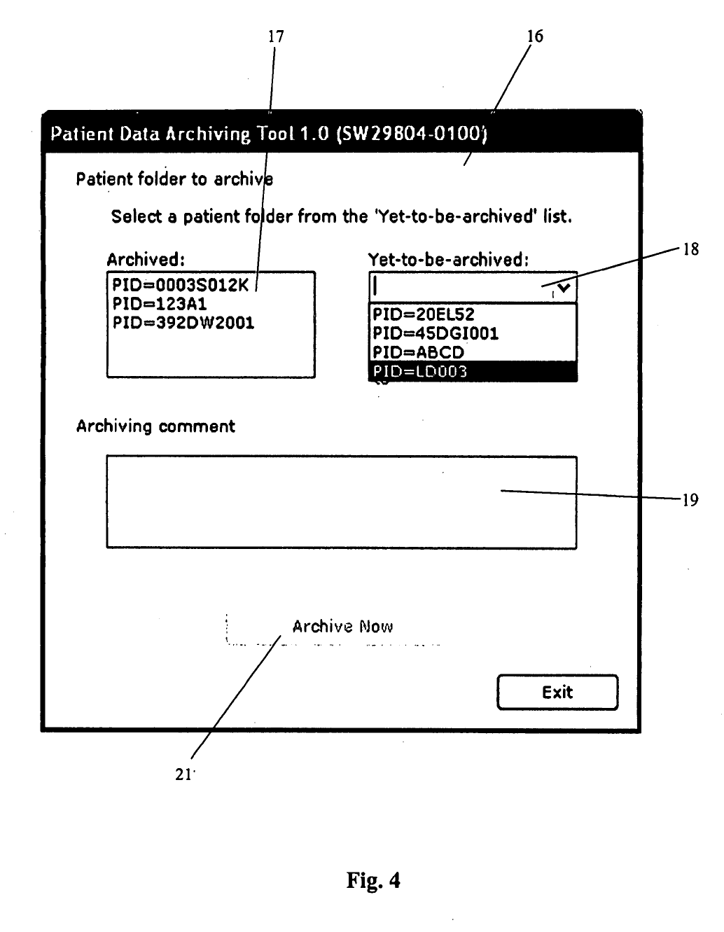

FIG. 4 through 6 depicts images of application software 8 when it is activated on a laptop computer 1. The representations demonstrate the images the user would see when initiating the archiving of the patient data via a GUI 16.

The GUI 16 may include: a first text box listing already archived data; a second text box listing patient data that is yet to be archived from the computer 1; and a third text box 19 that allows the user to enter comments.

FIG. 4 depicts the GUI 16 at a stage, when the user selects the patient data to be archived in a session by clicking the appropriate entry in the second text box 18. Then the user may click on the button 21 marked “Archive Now”. The application software 8 then initiates the archiving process in accordance with FIG. 3.

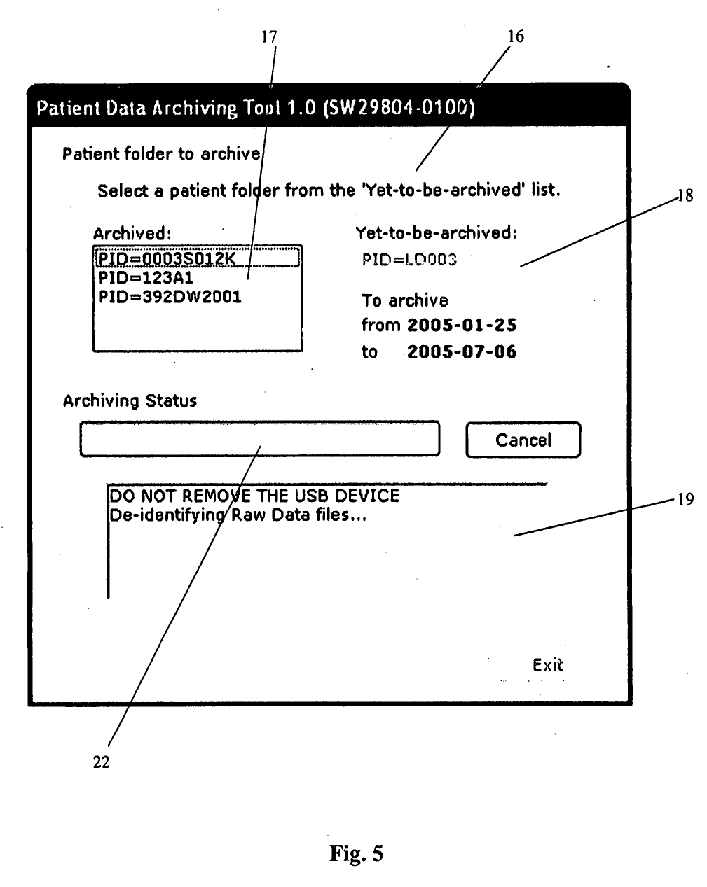

FIG. 5 depicts the GUI 16 after the user has selecting patient data to be archived and clicked button 21. The message in the third text box 19 is issued by the application software 8 and informs the user of the progress of the archiving process. Preferably, a bar graph 22 may be included to demonstrate graphically to the user the progress of the archiving process by the application software 8. Typically this bar graph 22 is positioned in close proximity to the third text box 19.

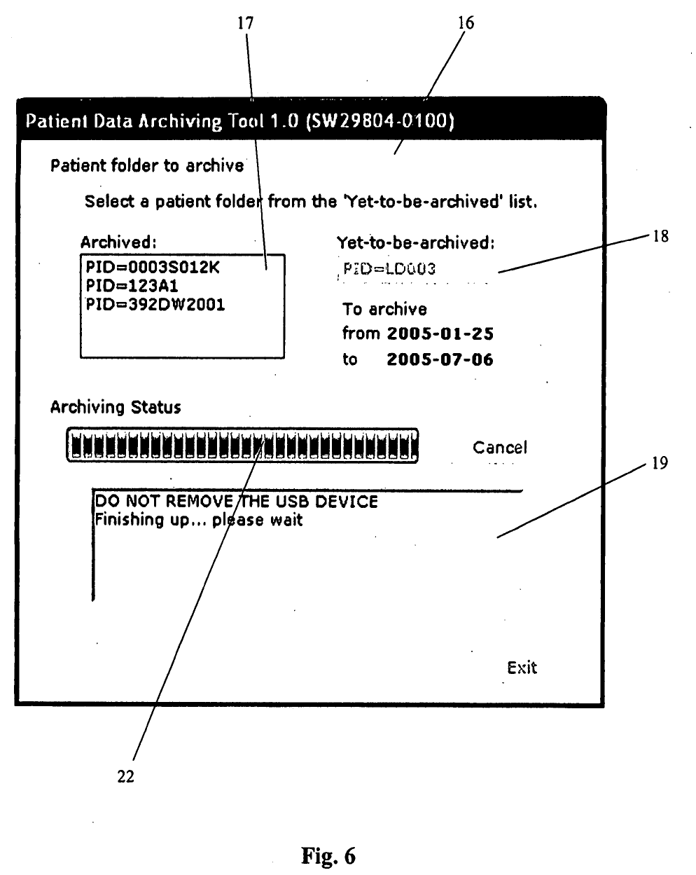

FIG. 6 depicts the GUI 16 after the application software 8 has successfully archived the selected patient data to the removable media 4. The third text box preferably shows a message confirming the success to the user and the bar graph 22 may also indicate that the process has been completed.

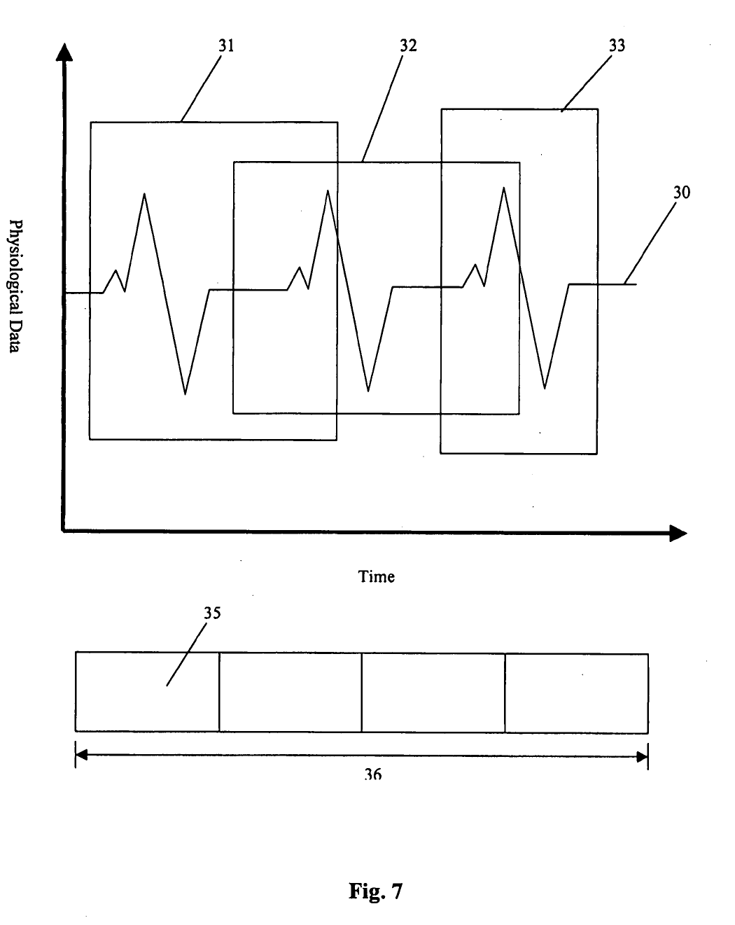

FIG. 7 depicts a graphical representation of some sample data that may be recorded and processed by the first embodiment of the present invention. In this graph, physiological data 30 is plotted against time. The physiological data 30 may include data relating to a pulse rate, a pumping speed, blood pressures, blood flow rates, or a combination thereof.

Generally, the controller 2 records the physiological data 30 from the medical device 3 over a time period. The user may then download this physiological data 30 to a computer 1. In the graph depicted in FIG. 7, a first download window 31 is illustrated. This first download window 31 represents the physiological data 30 recorded over a first time period. In this embodiment, the next download of physiological data 30 from the controller 2 occurs at the end of the time interval depicted by a second download window 31. Each download window is essentially similar to a recorded snapshot of physiological data 30 over the entire time period. Once the download of the second download window 32 has occurred the computer 1 may then stitch the data together to form a single consolidated graph. The computer 1 estimates and anticipates the overlaps in the overall data recorded with respect to the first and second download windows 31 & 32. Thereby, the computer 1 may remove the need for all of the data to be recorded and downloaded at set times. Additionally, the resolution of the data may vary between download windows.

Furthermore additional physiological data 30 may be added to the graph by way of more download windows. A third download window 33 in FIG. 7 adds additional physiological data 30 in this way and may be merged into the overall data included within the graph.

When the archiving step occurs the overall physiological data 36 is packaged and preferably compressed into data portions 35. Generally, these data portions 35 are of a fixed or predetermined size and may be stored in separate individual files.

It should be understood that whilst the software that performs the operation to separate the patient data and copies “desired information” to the removable media 4 and deletes the “undesired information” (confidential information) may typically reside on the computer 1, it should be understood that such software may in other embodiments reside on the removable media 4, or be contained in hardware (not shown) housed within the removable media 4.

The above descriptions detail only some of the embodiments of the present invention. Modifications may be obvious to those skilled in the art and may be made without departing from the scope and spirit of the present invention.

1. A method of archiving on a removable media, desired information retrieved from a medical device implanted within a patient, said method comprising the steps of transferring patient data from said medical device to a computer, performing an operation on said patient data within said computer to separate it into a first category of desired information and a second category of undesired information, copying said desired information to said removable media from said computer, and deleting said undesired information from said computer.

2. A method as claimed in claim 1, wherein said method comprises compressing said desired information prior to transferring same to said removable media.

3. A method as claimed in claims 1 or 2 wherein said undesired information is confidential information.

4. An apparatus for archiving on a removable media, desired information retrieved from a medical device implanted within a patient, said apparatus adapted to engage with a computer that has patient data therein that has been transferred from said medical device, said apparatus adapted to perform an operation on said patient data that separates it into a first category of desired information and a second category of undesired information, said apparatus further adapted to copy said desired information to said removable media and to delete said undesired information from said computer.

5. An apparatus as claimed in claim 4, wherein said apparatus compresses said desired information prior to transferring same from said computer to said removable media.

6. An apparatus as claimed in claims 4 or 5 wherein said apparatus and said removable media are housed within a single unit.

7. An apparatus as claimed in claim 6 wherein removable media is a USB flash drive.
